(19) United States
(12) Patent Application Publication
(10) Pub. No.: US 2009/0158415 A1
(43) Pub. Date: Jun. 18, 2009

(54) METHOD AND APPARATUS OF PROVIDING AN INTERFACE FOR MANAGING NETWORK SWITCHES

(75) Inventor: Jimmy D. DILLON, Collinsville, OK (US)

Correspondence Address: VERIZON;PATENT MANAGEMENT GROUP, 1320 North Court House Road, 9th Floor, ARLINGTON, VA, 22201-2909, US

(73) Assignee: Verizon Business Network Services Inc., Ashburn, VA (US)

(21) Appl. No.: 11/957,851

(22) Filed: Dec. 17, 2007

(51) Int. Cl. G06F 15/16; G06F 3/048; G06F 21/20; G06F 17/30

(52) U.S. Cl. 726/11; 709/227; 715/810; 707/100; 707/E17.044

(57) ABSTRACT

An approach is provided for presenting, via a graphical user interface, a plurality of selectable areas corresponding to a plurality of categories of switches and a plurality of options. One of the options includes a search function for finding a desired one of the switches. A communication session is automatically established with one of the switches as specified by a user through one of the selectable areas or the search function. Information from the one switch is received over the communication session, wherein the information is used for analyzing the one switch.

### BACKGROUND INFORMATION

With the ubiquitous deployment of communication networks for a wide range of communication services, management of the associated network devices (which can number in the hundreds if not thousands) can be a daunting task for network managers. For example, in telephony networks, the number and types of voice switches vary from traditional circuit-switched switches to packetized voice switches (e.g., Voice Over Internet Protocol (VoIP) services). Also, these networks can have a global footprint, thereby introducing further challenges. From a network management perspective, these factors of diversity in switch types and locations have spawn ad hoc, labor intensive processes and management mechanisms. Given the competitiveness of communication offerings, service providers must maintain a high level of network availability and reliability to ensure consumer satisfaction and loyalty. To accomplish this, information from these devices to perform maintenance and troubleshooting needs to be acquired rapidly and efficiently.

Therefore, there is a need for an approach that permits a user to access information quickly and conveniently from network devices for proper management of the corresponding network.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIG. 1 is a diagram of a system capable of managing network switches, according to an exemplary embodiment;

FIG. 2 is a flowchart of a process for managing switch connections, according to an exemplary embodiment;

FIG. 3 is a diagram of a user interface providing a search capability in the management of network switches, according to an exemplary embodiment;

FIG. 4 is a diagram of a user interface providing a tabbed arrangement of network switches, according to an exemplary embodiment;

FIG. 5 is a diagram of a user interface for managing multiple communication sessions with network switches, according to an exemplary embodiment;

FIG. 6 is a diagram of a user interface for inputting alphanumeric text in the management of network switches, according to an exemplary embodiment;

FIG. 7 is a diagram of a user interface providing a menu of tools for managing the network switches, according to an exemplary embodiment; and

FIG. 8 is a diagram of a computer system that can be used to implement various exemplary embodiments.

### DESCRIPTION OF THE PREFERRED EMBODIMENT

A preferred apparatus, method, and software for providing an interface to manage network switches are described. In the following description, for the purposes of explanation, numerous specific details are set forth in order to provide a thorough understanding of the preferred embodiments of the invention. It is apparent, however, that the preferred embodiments may be practiced without these specific details or with an equivalent arrangement. In other instances, well-known structures and devices are shown in block diagram form in order to avoid unnecessarily obscuring the preferred embodiments of the invention.

Although various exemplary embodiments are described with respect to a telecommunication switches configured to provide voice services and the Telnet protocol, it is recognized that the approach described herein has applicability to network devices that support other communication services, and other protocols for accessing remote network devices.

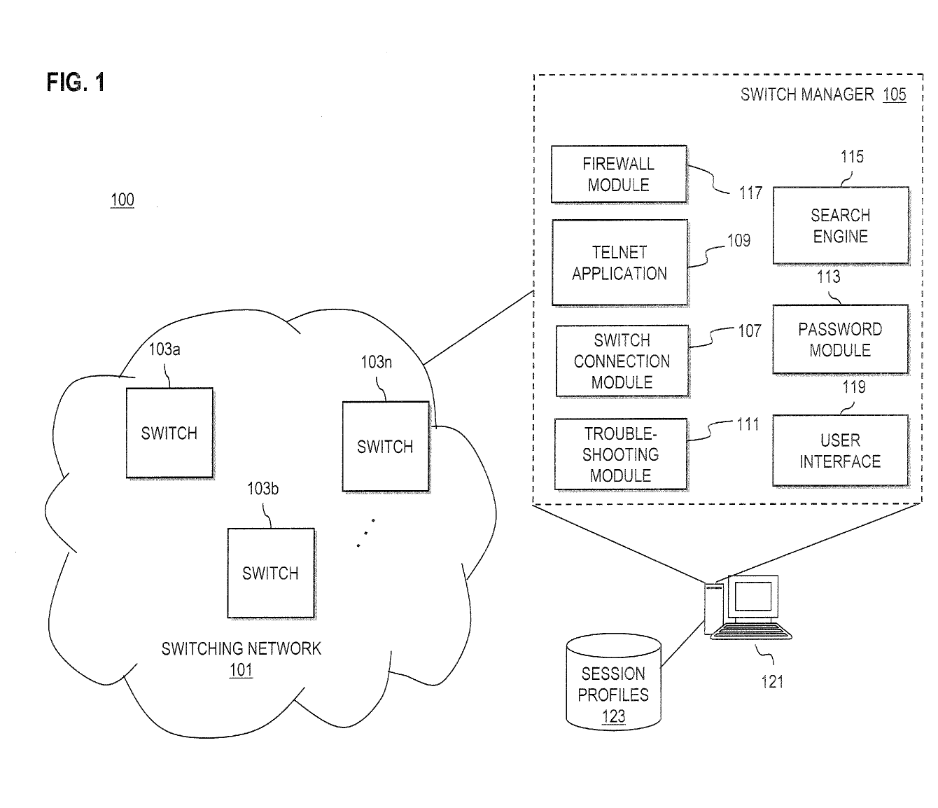

FIG. 1 is a diagram of a system capable of managing network switches, according to an exemplary embodiment. A communication system 100 includes a switching network 101 encompassing multiple switches 103a-103n. As seen, a switch manager 105, among other functions, can provide management of connectivity to the switches 103a-103n on the network 101 so as to provide case of acquiring information for analyzing the switch; exemplary information includes switch configuration information and/or troubleshooting information. The network 101 can be a telephony network that is geographically dispersed—e.g., domestically and/or internationally. According to one embodiment, the switch manager 105 utilizes a switch connection module 107 to establish communication sessions with the switches 103a-103n. The switch connection module 107 can access the switches 103a-103n using, for example, Telnet or Secure Shell (SSH) protocols. Thus, it is assumed that the switches 103a-103n possess a Telnet or SSH capability for remote management.

Telnet, which is a Transmission Control Protocol/Internet Protocol (TCP/IP) protocol, provides for accessing remote network devices. SSH is essentially secure Telnet, which encrypts all text exchanged with the network devices—e.g., commands and passwords. With SSH, a digital certificate authenticates the connection between the switch manager 105 and the switch. For example, SSH can utilize RSA encryption keys (e.g., SSH1), and Digital Signature Algorithm (DSA) keys (e.g., SSH2) to secure the connection and authentication. Telnet is further detailed in Internet Engineering Task Force (IETF) Request for Comment (RFC) 854, entitled “Telnet Protocol Specification,” and RFC 855, entitled “Telnet Options Specifications”; which are incorporated herein by reference in their entireties. Also, SSH is more fully described in RFC 4251, entitled “The Secure Shell (SSH) Protocol Architecture,” which is incorporated herein by reference in its entirety.

In an exemplary embodiment, the switch connection module 107 operates in conjunction with a Telnet application 109 to set-up these sessions. This approach of interfacing with the switches 103a-103n is commonly referred to as “the command line.” Telnet sessions support exchange of commands to such switches 103a-103n. These interface commands can elicit any type of information about the switches 103a-103n, such as status information, identifier, device type, capacity, statistical data, etc. For instance, through such communication sessions, the switch manager 105 can gather switch information relating to any problems or malfunction of the switches 103a-103n for processing by a trouble-shooting module 111. A password module 113 maintains the passwords need to access the various switches 103a-103n.

To assist with locating a particular switch of interest, the switch manager 105 has a search engine 115 that permits a user to find a specific switch among the many switches 103a-103n. The search engine 115 is integrated with the switch manager 105 to provide the user with the ability to search for any pertinent information regarding the switch or Telnet applications. In actual systems, the number of switches 103a-103n can be in the hundreds or even thousands; consequently, manually search for a switch can be rather cumbersome and time consuming. In the exemplary system 101, a firewall module 117 provides an integrated security approach to protect against unauthorized access of the resources (e.g., data) of the switch manager 105.

Traditionally, Telnet sessions have been stored in actual files on a shared network drive, for example. These actual files were subject to inadvertent deletion. Under such a conventional system, no user defined sessions existed. With respect to user interface, this system requires the user to undergo an onerous process to collect switch information, whereby the user had to navigate through numerous folders and files to access switch type and location.

By contrast, the switch manager 105 provides a user interface 119 that supports automated switch connection establishment and robust search capability. Although shown as resident within a computer device 121, it is contemplated that the switch manager 105 can be a standalone system. The computer device 121 maintains session profiles locally within a database 123. By way of example, the computer device 121 may be a desktop computer, notebook computer, server, terminal workstation, customized hardware, or other equivalent apparatus. It is noted that the sessions can be unique to each user, according to one embodiment; also, actual files are utilized as reference only and are not subject to deletion. With the user interface 119, the user can, for example, access and search switch type and location with minimal keyboard strokes.

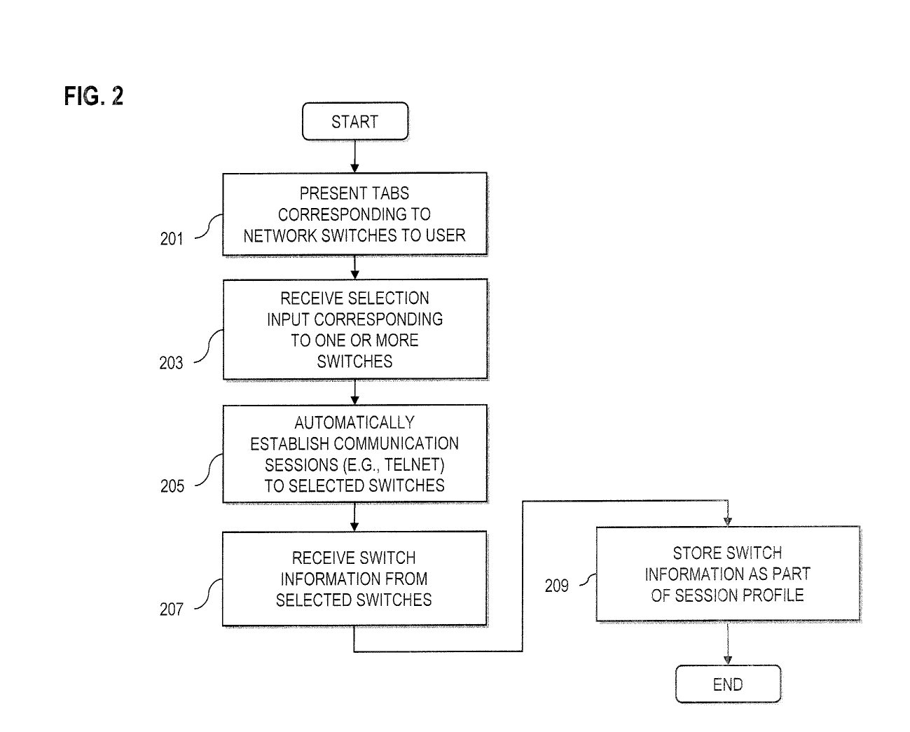

The user interface 119 is more fully described below with respect to FIGS. 2-7.

FIG. 2 is a flowchart of a process for managing switch connections, according to an exemplary embodiment. Continuing with the exemplary system 101, in step 201, the user interface 119 presents tabs (or other selectable areas) corresponding to the network switches 103a-103n. The switch manager 105 receives, from a user, input corresponding to one or more switches 103a-103n, as in step 203. Per step 205, the switch manager 105 can automatically establish communication sessions (e.g., Telnet) to the selected switches 103a-103n.

At this point, the switch manager 105 can collect switch information from the specified switches 103a-103n, as in step 207. In step 209, the switch information transmitted through the communication sessions can be stored as part of a session profile.

The above process improves the Telnet session management procedure by managing the connectivity to the switches 103a-103n more efficiently.

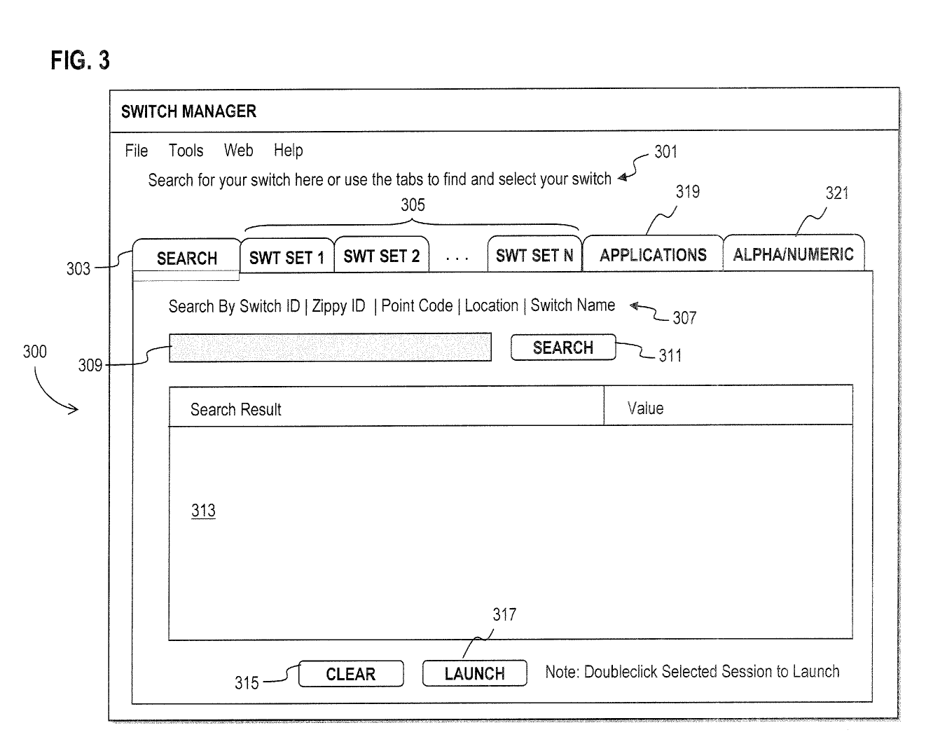

FIG. 3 is a diagram of a user interface providing a search capability in the management of network switches, according to an exemplary embodiment. By way of example, the user interlace 119 is a graphical user interface (GUI) that provides a search screen 300. The screen 300 displays a textual prompt 301 to the user: “Search for your switch or use the tabs to find and select your switch.” An arrangement of tabs 305 is displayed to the user; these tabs 305 correspond to the switches 103a-103n. In an exemplary embodiment, the tabs 305 categorize the switches 103a-103n according to predefined categories—e.g., switch types, location, services, etc. In this example, the user elects to invoke the search capability, rather than choosing one of the tabs.

Accordingly, the user selects a search tab 303 to search for a particular switch. That is, the user has a search interface that can accept partial names of switches and return full names of switches, thereby allowing the user to directly find a particular switch based on short strings typed into the interface. As seen, various mechanisms are provided to assist the user to efficiently search. For example, selectable textual options 307 are displayed by Switch ID (identification), Zippy ID, Point Code, Location, or Switch Name. Alternatively, the user may type any identifier in text box 309 and click on Search button 311 to initiate a search for the subject switch or switches. A search result box 313 is displayed after the switch manager 105 executes the search using the search engine 115. The search result box 313 can list the search results along with the associated values.

The user has the option to clear the search by using a Clear button 315. This button 315 is useful for performing a new search, as to avoid the need for the user to manually delete the entries. Stray entries can yield incorrect search results. Moreover, a Launch button 317 can be selected to establish connection to the switch yielded by the search.

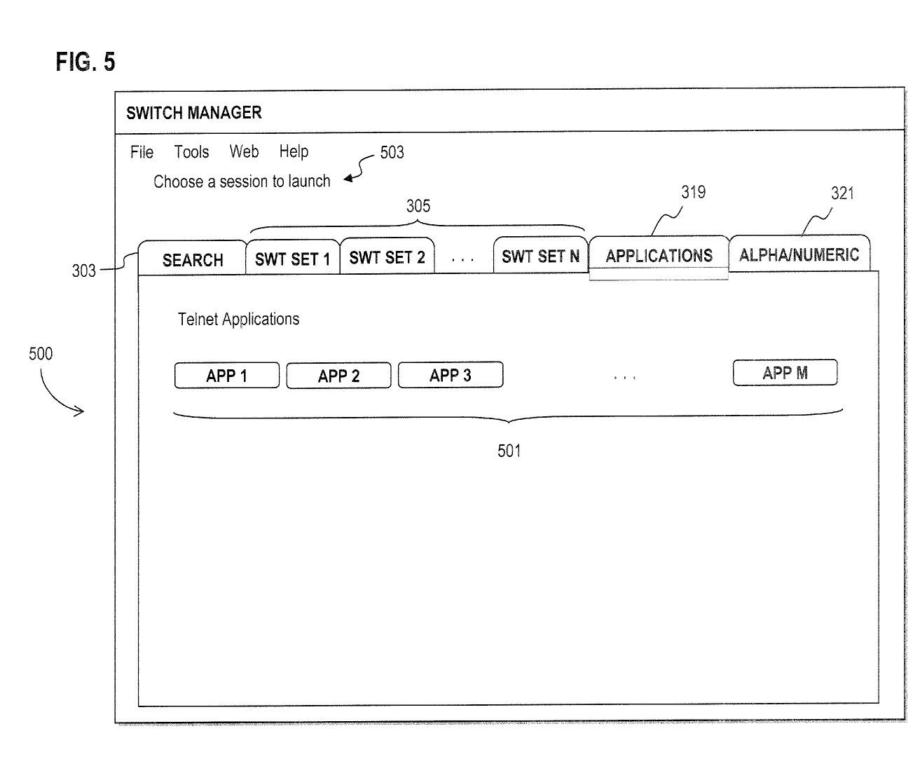

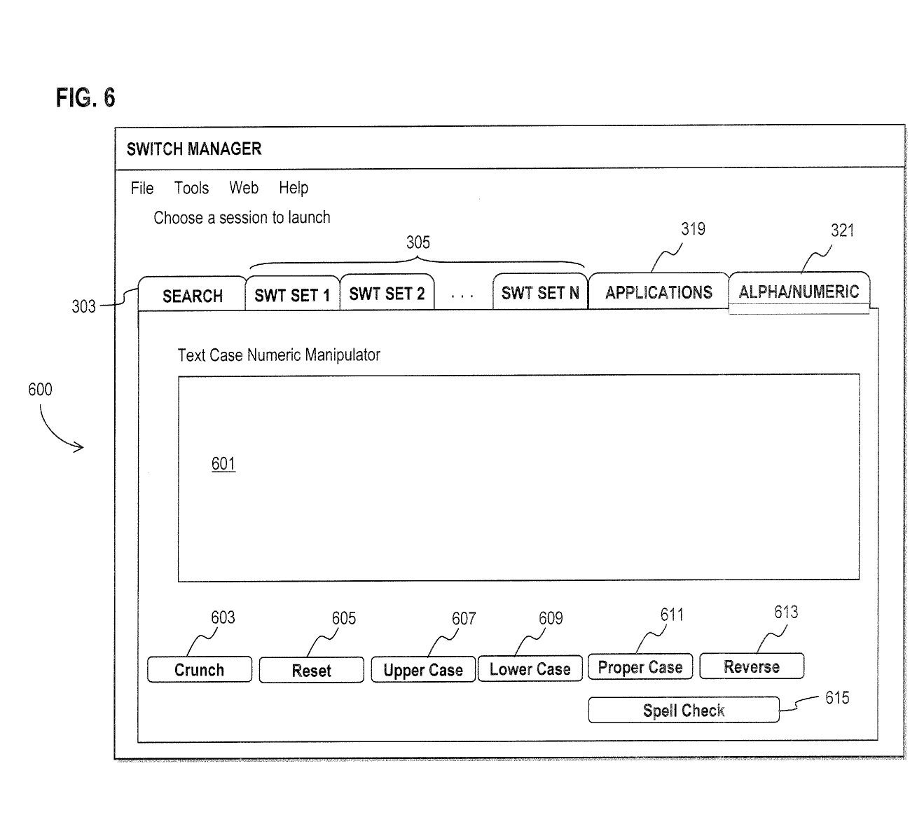

Furthermore, an applications tab 319 is presented to the user. This tab 319 provides the user with the ability to view the available Telnet sessions (as more fully described with respect to FIG. 5). Additionally, an alpha/numeric tab 321 permits the user with a capability to edit the switch identifiers; this process is explained in FIG. 6.

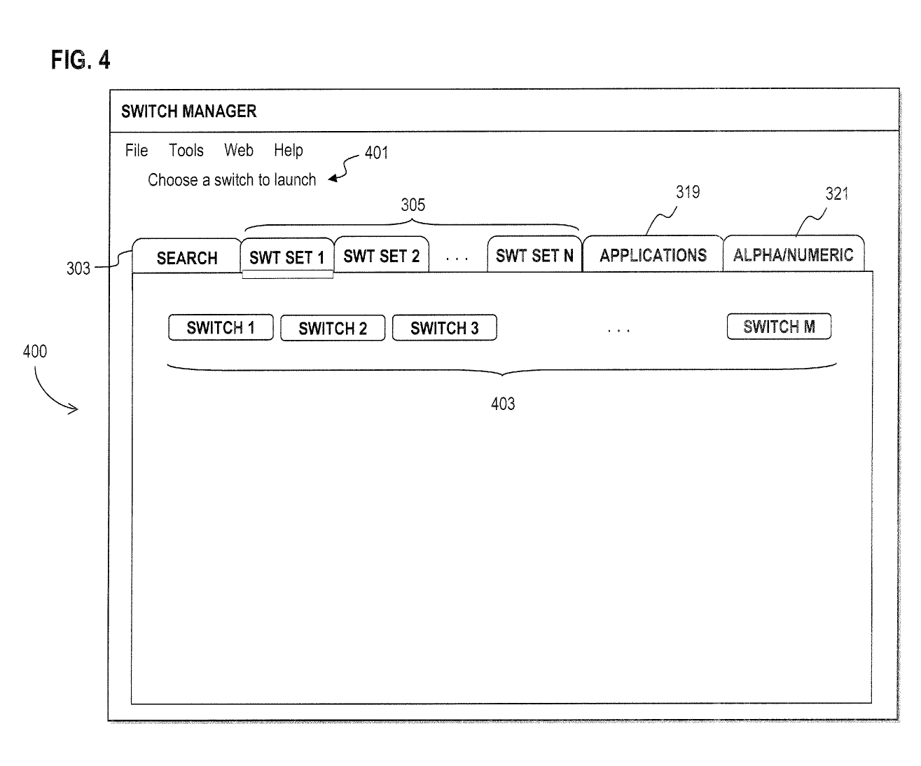

FIG. 4 is a diagram of a user interface providing a tabbed arrangement of network switches, according to an exemplary embodiment. Screen 400 enables a user to directly select a switch, in lieu of conducting a search. An appropriate prompt 401 states, “Choose a switch to launch.” Under this scenario, the user can select (e.g., by clicking using a mouse device or other input means) on a tab corresponding to a switch set or category, “switch set 1”; according to one embodiment, the names of the switches in the category are displayed. The selection of this tab results in the presentation of the switches within the particular category (e.g., domestic switches, international switches, Voice over IP (VoIP) switches, etc.). For the purposes of explanation, these switches are represented by buttons 403: Switch 1 . . . Switch M. In an exemplary embodiment, these buttons 403 are dynamic and can be controlled and created by a single configuration file (e.g., Microsoft Windows “.ini” files); the configuration file can be stored within a shared network drive behind the firewall 117.

If the user chooses on a particular switch among the displayed switches, a Telnet session is opened with the chosen switch in another window, for example. The password module 113 manages the user passwords for all the switches under the responsibility of the switch manager 105; thus, the communication session can be automated—i.e., does not require user input of the password (which can be a tedious process if multiple sessions are established).

FIG. 5 is a diagram of a user interface for managing multiple communication sessions with network switches, according to an exemplary embodiment. With screen 500, the user has selected the applications tab 319, which displays the available communication sessions (e.g., Telnet applications) 501. A prompt 503 can instruct the user to “Choose a session to launch.”

Additionally, text documents (not shown) with tabs can be created through the user interface 119 based on the open Telnet sessions, thereby allowing the user to record information about the switch configuration, or a problem with the switch for later use in a Telnet session.

FIG. 6 is a diagram of a user interface for inputting alphanumeric text in the management of network switches, according to an exemplary embodiment. Screen 600 provides the Alpha/Numeric tab 321 can be utilized to modify switch records, e.g., call detail records (CDR). For example, this screen 600 can be used to remove spaces and dashes from phone numbers, as well as manipulating the cases of text (i.e., all upper case, lower case, or proper case). An editing box 601 permits the user to enter textual information for modification. The screen 600 additionally provides various editing functions in form of buttons: Crunch 603, Reset 605, Upper Case 607, Lower Case 609, Proper Case 611, Reverse 613, and Spell Check 615. These functions are helpful when the user needs to perform copying and pasting of information into trouble tickets, for instance. The Crunch button 603 eliminates extraneous characters in a text string, thereby compressing the text string. For example, this function can be used to allow the user to copy a phone number with just the numeric digit, in which the spaces, dashes or dots are automatically removed. This capability is particularly useful for copying or transferring long strings, such as international phone numbers, into applications to find particular call detail records. The Reset button 605 can restore the text into its original version, while the buttons 607-613 provide formatting changes to the text. Furthermore, the Spell Check button 615 permits the user to determine whether the text contains spelling errors.

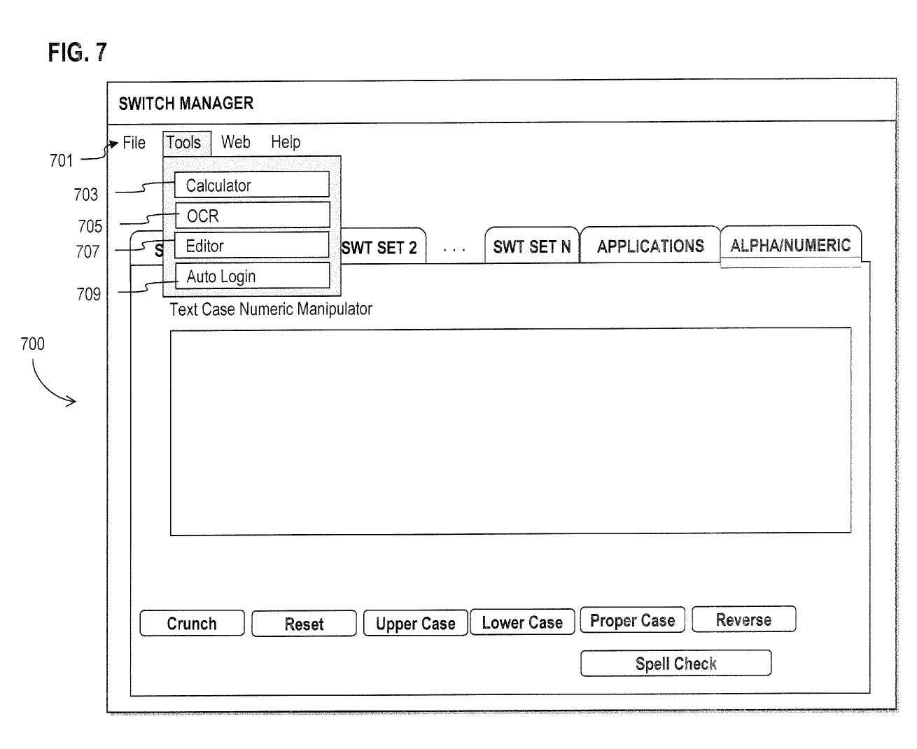

FIG. 7 is a diagram of a user interface providing a menu of tools for managing the network switches, according to an exemplary embodiment. The user interface 119 further provides a screen 700 that displays the following options in a menu 701: File, Tool, Web, and Help. The File option can include an option to exit the switch manager 105, for example. As shown, the Tool option can provide such functions as Calculator 703 for basic mathematical functions, and Optical Character Recognition (OCR) 705 for converting an image file into a text file. The Tool option can also include an Editor function 707 to allow the user to modify or otherwise edit a file. Further, an Auto Login function 709 within the Tool set enables the user to initiate a login procedure with a particular switch, for instance.

Further, the menu 701 has a Web option that provides the user with access to web-based applications, such as a search engine, or other useful websites or web-based programs. Additionally, the menu 701 provides a Help option, which can include information about the switch manager 105 and its various functions.

The described GUI of FIGS. 3-7 overcomes the drawbacks of conventional approaches for switch management by providing automated switch connection establishment as well as search capability. Under this arrangement, a user can utilize a personal switch login to access a streamlined database for switch information (e.g., configuration information, information for troubleshooting, etc.), thereby minimize the time needed to manage the communication sessions the switches. Additionally, such information is securely stored in a single file via a firewall.

The processes described herein for providing the remote management process and user interfaces may be implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

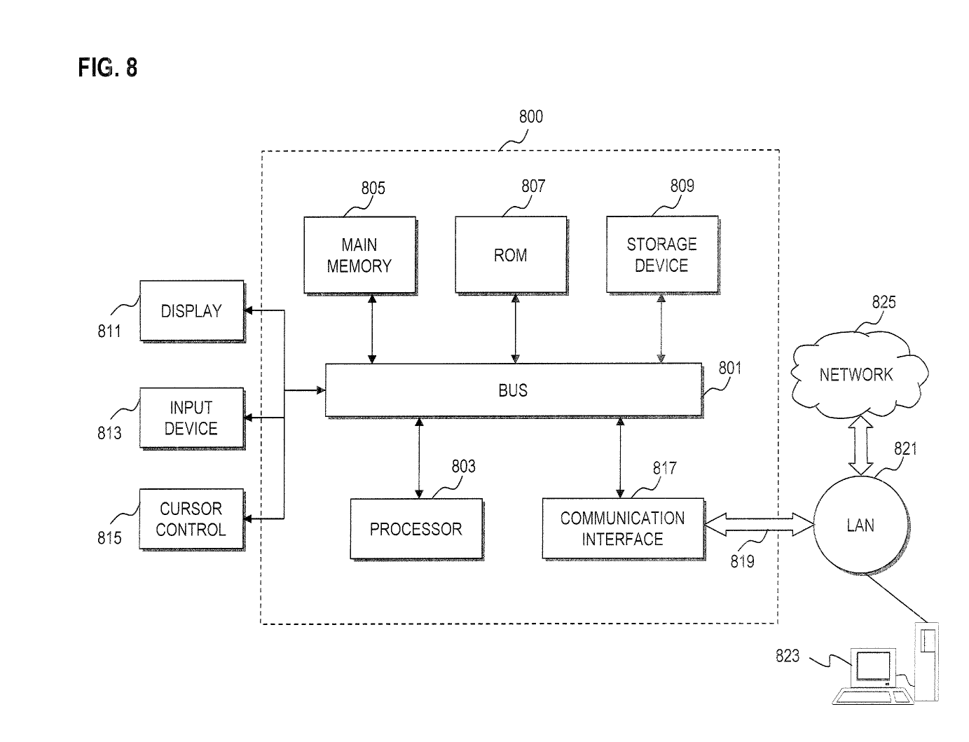

FIG. 8 illustrates computing hardware (e.g., computer system) 800 upon which an embodiment according to the invention can be implemented. The computer system 800 includes a bus 801 or other communication mechanism for communicating information mid a processor 803 coupled to the bus 801 for processing information. The computer system 800 also includes main memory 805, such as a random access memory (RAM) or other dynamic storage device, coupled to the bus 801 for storing information and instructions to be executed by the processor 803. Main memory 805 can also be used for storing temporary variables or other intermediate information during execution of instructions by the processor 803. The computer system 800 may further include a read only memory (ROM) 807 or other static storage device coupled to the bus 801 for storing static information and instructions for the processor 803. A storage device 809, such as a magnetic disk or optical disk, is coupled to the bus 801 for persistently storing information and instructions.

The computer system 800 may be coupled via the bus 801 to a display 811, such as a cathode ray tube (CRT), liquid crystal display, active matrix display, or plasma display, for displaying information to a computer user. An input device 813, such as a keyboard including alphanumeric and other keys, is coupled to the bus 801 for communicating information and command selections to the processor 803. Another type of user input device is a cursor control 815, such as a mouse, a trackball, or cursor direction keys, for communicating direction information and command selections to the processor 803 and for controlling cursor movement on the display 811.

According to an embodiment of the invention, the processes described herein are performed by the computer system 800, in response to the processor 803 executing an arrangement of instructions contained in main memory 805. Such instructions can be read into main memory 805 from another computer-readable medium, such as the storage device 809. Execution of the arrangement of instructions contained in main memory 805 causes the processor 803 to perform the process steps described herein. One or more processors in a multi-processing arrangement may also be employed to execute the instructions contained in main memory 805. In alternative embodiments, hard-wired circuitry may be used in place of or in combination with software instructions to implement the embodiment of the invention. Thus, embodiments of the invention are not limited to any specific combination of hardware circuitry and software.

The computer system 800 also includes a communication interface 817 coupled to bus 801. The communication interface 817 provides a two-way data communication coupling to a network link 819 connected to a local network 821. For example, the communication interface 817 may be a digital subscriber line (DSL) card or modem, an integrated services digital network (ISDN) card, a cable modem, a telephone modern, or any other communication interface to provide a data communication connection to a corresponding type of communication line. As another example, communication interface 817 may be a local area network (LAN) card (e.g. for Ethernet™ or an Asynchronous Transfer Model (ATM) network) to provide a data communication connection to a compatible LAN. Wireless links can also be implemented. In any such implementation, communication interface 817 sends and receives electrical, electromagnetic, or optical signals that carry digital data streams representing various types of information. Further, the communication interface 817 can include peripheral interface devices, such as a Universal Serial Bus (USB) interface, a PCMCIA (Personal Computer Memory Card International Association) interface, etc. Although a single communication interface 817 is depicted in FIG. 8, multiple communication interfaces can also be employed.

The network link 819 typically provides data communication through one or more networks to other data devices. For example, the network link 819 may provide a connection through local network 821 to a host computer 823, which has connectivity to a network 825 (e.g. a wide area network (WAN) or the global packet data communication network now commonly referred to as the “Internet”) or to data equipment operated by a service provider. The local network 821 and the network 825 both use electrical, electromagnetic, or optical signals to convey information and instructions. The signals through the various networks and the signals on the network link 819 and through the communication interface 817, which communicate digital data with the computer system 800, are exemplary forms of carrier waves bearing the information and instructions.

The computer system 800 can send messages and receive data, including program code, through the network(s), the network link 819, and the communication interface 817. In the Internet example, a server (not shown) might transmit requested code belonging to an application program for implementing an embodiment of the invention through the network 825, the local network 821 and the communication interface 817. The processor 803 may execute the transmitted code while being received and/or store the code in the storage device 809, or other non-volatile storage for later execution. In this mariner, the computer system 800 may obtain application code in the form of a carrier wave.

The term “computer-readable medium” as used herein refers to any medium that participates in providing instructions to the processor 803 for execution. Such a medium may take many forms, including but not limited to non-volatile media, volatile media, and transmission media. Non-volatile media include, for example, optical or magnetic disks, such as the storage device 809. Volatile media include dynamic memory, such as main memory 805. Transmission media include coaxial cables, copper wire and fiber optics, including the wires that comprise the bus 801. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the embodiments of the invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computer device, such as a personal digital assistant (PDA) or a laptop. An infrared detector on the portable computer device receives the information and instructions borne by the infrared signal and places the data on a bus. The bus conveys the data to main memory, from which a processor retrieves and executes the instructions. The instructions received by main memory can optionally be stored on storage device either before or after execution by processor.

While certain exemplary embodiments and implementations have been described heroin, other embodiments and modifications will be apparent from this description. Accordingly, the invention is not limited to such embodiments, but rather to the broader scope of the presented claims and various obvious modifications and equivalent arrangements.

What is claimed is:

1. A method comprising:
presenting, via a graphical user interface, a plurality of selectable areas corresponding to a plurality of categories of switches and a plurality of options, wherein one of the options includes a search function for finding a desired one of the switches;
automatically establishing a communication session with one of the switches as specified by a user through one of the selectable areas or the search function; and
receiving information from the one switch over the communication session, wherein the information is used for analyzing the one switch.

2. A method according to claim 1, wherein the selectable areas are arranged as a plurality of tabs.

3. A method according to claim 2, wherein another one of the options includes a list of communication sessions corresponding to corresponding ones of the switches.

4. A method according to claim 1, further comprising:
storing the information as part of a session profile for the user.

5. A method according to claim 4, wherein the information is stored in a network drive, the method further comprising:
providing a firewall to selectively permit access to the stored information.

6. A method according to claim 1, wherein the information includes configuration information, troubleshooting information, or a combination thereof.

7. A method according to claim 1, wherein the communication session is established according to a Telnet protocol or a Secure Shell protocol.

8. A method according to claim 1, wherein the categories include switch type, switch location, or a combination thereof.

9. An apparatus comprising:
a graphical user interface configured to present a plurality of selectable areas corresponding to a plurality of categories of switches and a plurality of options, wherein one of the options includes a search function for finding a desired one of the switches;
a switch connection module configured to automatically establish a communication session with one of the switches as specified by a user through one of the selectable areas or the search function; and
an application configured to receive information from the one switch over the communication session, wherein the information is used for analyzing the one switch.

10. An apparatus according to claim 9, wherein the selectable areas are arranged as a plurality of tabs.

11. An apparatus according to claim 10, wherein another one of the options includes a list of communication sessions corresponding to corresponding ones of the switches.

12. An apparatus according to claim 9, further comprising:
a database configured to store the information as part of a session profile for the user.

13. An apparatus according to claim 12, further comprising:
a firewall configured to selectively permit access to the stored information.

14. An apparatus according to claim 9, wherein the information includes configuration information, troubleshooting information, or a combination thereof.

15. An apparatus according to claim 9, wherein the communication session is established according to a Telnet protocol or a Secure Shell protocol.

16. An apparatus according to claim 9, wherein the categories include switch type, switch location, or a combination thereof.

17. A user interface comprising:
a plurality of tabs corresponding to a plurality of categories of switches and a plurality of options,
wherein one of the options includes a search function for finding a desired one of the switches,
wherein a communication session is automatically established with one of the switches based on input by a user through one of the tabs or the search function, the communication session transporting information from the one switch.

18. An apparatus according to claim 17, further comprising:
a clear button configured to clear input values corresponding to the search function.

19. An apparatus according to claim 17, further comprising:
a launch button configured to initiate the automatic establishment of the communication session with one of the switches resulting from the search function.

20. An apparatus according to claim 17, wherein another one of the options includes a list of communication sessions corresponding to corresponding ones of the switches.

21. An apparatus according to claim 17, wherein the information includes configuration information, troubleshooting information, or a combination thereof.

22. An apparatus according to claim 17, wherein the communication session is established according to a Telnet protocol or a Secure Shell protocol.

23. An apparatus according to claim 17, wherein the categories include switch type, switch location, or a combination thereof.
